(19) United States
(12) Patent Application Publication
(10) Pub. No.: US 2019/0304059 A1
(43) Pub. Date: Oct. 3, 2019

(54) IMAGE PROCESSING DEVICE AND DISPLAY DEVICE

(71) Applicant: SHARP KABUSHIKI KAISHA, Sakai City (JP)

(72) Inventors: TATSUHIKO SUYAMA, Sakai City (JP); NORIYUKI TANAKA, Sakai City (JP); KOHICHI OHHARA, Sakai City (JP); TAKUYA HANDA, Sakai City (JP)

(21) Appl. No.: 16/370,597

(22) Filed: Mar. 29, 2019

(30) Foreign Application Priority Data
Apr. 3, 2018 (JP) 2018-071590

(51) Int. Cl. G06T 1/60; G09G 3/20

(52) U.S. Cl. CPC G06T 1/60; G09G 2360/12; G09G 3/2007

(57) ABSTRACT

To carry out a suitable correction process while preventing a cost increase, an image processing device includes a frame memory (120) configured to store image data for the current frame; and a correction section (130, 140) configured to correct an image for the current frame, the correction section being configured to correct the image for the current frame with reference to a frame previous to the current frame, the frame memory being configured to further store image data for the previous frame.

This Nonprovisional application claims priority under 35 U.S.C. § 119 on Patent Application No. 2018-071590 filed in Japan on Apr. 3, 2018, the entire contents of which are hereby incorporated by reference.

### TECHNICAL FIELD

The present invention relates to an image processing device and a display device.

### BACKGROUND ART

There has been known a technique of referring to a previous frame for a process of correction of the current frame. Patent Literature 1, for example, discloses a technique of using an encoding circuit and a decoding circuit during overshoot drive (overdrive) as an example of the correction process to (i) reduce the necessary frame memory capacity and (ii) prevent unnecessary overshoot drive for display of a still image.

### CITATION LIST

### Patent Literature

[Patent Literature 1]

Japanese Patent Application Publication, Tokukai, No. 2008-129208 (Publication Date: Jun. 5, 2008)

### SUMMARY OF INVENTION

### Technical Problem

Conventional techniques such as the above unfortunately require a dedicated frame memory to store image data for a previous frame, and thus cause a cost increase.

An image processing device in accordance with an aspect of the present invention has been accomplished in view of the above issue, and has an object of carrying out a suitable correction process while preventing a cost increase.

### Solution to Problem

In order to attain the above object, an image processing device in accordance with an aspect of the present invention includes: an input section configured to accept input image data; a frame memory configured to store image data for a current frame which image data is included in the input image data that the input section has accepted; and a correction section configured to correct an image for the current frame, the correction section being configured to correct the image for the current frame with reference to a frame previous to the current frame, the frame memory being configured to further store image data for the previous frame.

### Advantageous Effects of Invention

An aspect of the present invention makes it possible to carry out a suitable correction process while preventing a cost increase.

### BRIEF DESCRIPTION OF DRAWINGS

FIG. 1 is a block diagram illustrating the configuration of a display device 1 in accordance with the present embodiment.

FIG. 2 is a diagram illustrating an example target image as a target of a process carried out by the display device 1 in accordance with the present embodiment.

FIG. 3A to FIG. 3C are each a diagram specifically illustrating how a boundary is set in the frame memory 120 in accordance with the present embodiment.

FIG. 4 is a block diagram illustrating the configuration of a display device 2 in accordance with the present embodiment.

FIG. 5A to FIG. 5B are each a diagram specifically illustrating how a boundary is set in the frame memory 120 in accordance with the present embodiment.

FIG. 6 is a diagram specifically illustrating how a boundary is set in the frame memory 120 in accordance with the present embodiment.

### DESCRIPTION OF EMBODIMENTS

### Embodiment 1

The following description will discuss an embodiment of the present invention in detail.

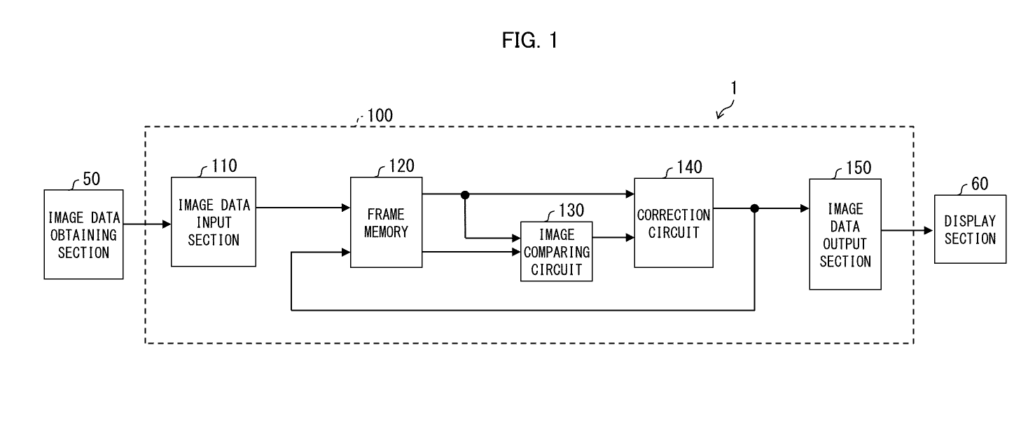

FIG. 1 is a block diagram illustrating the configuration of a display device 1 in accordance with the present embodiment. As illustrated in FIG. 1, the display device 1 includes an image data obtaining section 50, an image processing device 100, and a display section 60. The image data obtaining section 50 obtains image data to be supplied to the display device 1. The image data obtaining section 50 has, for example, an interface that conforms to any of various standards. The display section 60 displays an image based on image data that the image processing device 100 has processed. The display section 60 includes, for example, (i) a panel such as a liquid crystal panel and an organic electroluminescent (EL) panel including organic light-emitting diodes (OLEDs) and (ii) a circuit for driving the panel. The display section 60 may alternatively be, for example, a quantum-dot light emitting diode (QLED) display including QLEDs as electrooptic elements.

Image Processing Device 100

The image processing device 100, as illustrated in FIG. 1, includes an image data input section (input section) 110, a single frame memory 120, an image comparing circuit 130, a correction circuit 140, and an image data output section 150. The description below uses the term “correction section” as well to refer to a combination of the image comparing circuit 130 and the correction circuit 140.

The image data input section 110 accepts image data that the image data obtaining section 50 has obtained.

Frame Memory 120

The frame memory 120 includes, for example, a single memory chip.

The frame memory 120 may further include a memory control section for writing and reading data and controlling storage areas of the frame memory.

The frame memory 120 stores image data that the image data obtaining section 50 has obtained and image data that the correction circuit has outputted. The frame memory 120, more specifically, stores (i) at least a portion of image data for the current frame which image data has been inputted into the image data input section 110 and (ii) at least a portion of image data for a frame previous to the current frame which image data has been subjected to a correction process by the correction circuit 140.

Assuming as an example that the current frame is a frame N (where N is a nonnegative integer indicative of the frame number), the frame memory 120 stores (i) at least a portion of the frame N that has been inputted into the image data input section 110 and (ii) at least a portion of a frame N−1 that has been subjected to a correction process by the correction circuit 140. The frame memory 120 may alternatively store not a frame N−1 but a frame N−k (where k is a nonnegative integer of not greater than N) according to, for example, what correction process is carried out by the correction circuit 140 (described later). In other words, the frame memory 120 may store, as image data for a previous frame, at least a portion of image data for a frame that is two or more frames previous to the current frame.

The frame memory 120 of the above example stores at least a portion of image data for a frame previous to the current frame which image data has been subjected to a correction process by the correction circuit 140. The present embodiment is, however, not limited to such a configuration. The frame memory 120 may alternatively store at least a portion of image data for a frame previous to the current frame which image data has not been subjected to a correction process by the correction circuit 140.

The frame memory 120 has a variable boundary between an area for storing image data for the current frame and an area for storing image data for a frame previous to the current frame. A later description will deal with how the boundary is set in detail.

The description below uses the term “past frame” as well to refer to a frame that is immediately previous or two or more frames previous to the current frame.

Image Comparing Circuit 130

The image comparing circuit 130 compares (i) image data for the current frame which image data is stored in the frame memory 120 with (ii) image data for a past frame which image data is stored in the frame memory 120, and supplies the correction circuit 140 with the image data for a past frame according to the comparison result. The image comparing circuit 130 may be configured to transmit the comparison result to the correction circuit 140.

A specific process carried out by the image comparing circuit 130 does not limit the present embodiment. For instance, the image comparing circuit 130 compares image data for the current frame with image data for a past frame to determine whether an image being processed is a still image or a moving image. The image comparing circuit 130 may be configured to determine, for example, (i) whether at least a portion of an image being processed is a still image and (ii) if at least a portion of the image being processed is a still image, which region of the frame corresponds to the still image.

The image comparing circuit 130 carries out the determination process by, for instance, calculating the difference in pixel value between each pixel in a block of the current frame and the same pixel of a past frame.

If the Image Comparing Circuit 130 has Determined that an Image being Processed is a Still Image

If, for instance, the image comparing circuit 130 has determined that an image being processed is a still image, the image comparing circuit 130 transmits to the correction circuit 140 a determination result to the effect that the image being processed is a still image. The image comparing circuit 130, in this case, does not supply image data to the correction circuit 140.

If the Image Comparing Circuit 130 has Determined that an Image being Processed is a Moving Image

If, for instance, the image comparing circuit 130 has determined that an image being processed is a moving image, the image comparing circuit 130 transmits to the correction circuit 140 a determination result to the effect that the image being processed is a moving image and supplies the correction circuit 140 with image data for a past frame which image data is stored in the frame memory 120.

Correction Circuit 140

The correction circuit 140, with reference to image data supplied from the image comparing circuit 130, carries out a correction process on image data for the current frame which image data is stored in the frame memory 120.

If a Target Image is a Still Image

If, for instance, the correction circuit 140 has received from the image comparing circuit 130 a determination result to the effect that a target image is a still image, the correction circuit 140 does not carry out a correction process on the image data for the current frame which image data is stored in the frame memory 120.

If a Target Image is a Moving Image

If the correction circuit 140 has received from the image comparing circuit 130 a determination result to the effect that a target image is a moving image, the correction circuit 140, with reference to image data for a past frame which image data is supplied from the image comparing circuit 130, carries out an overdrive (overshoot) process as an example correction process on the image data for the current frame which image data is stored in the frame memory 120.

The overdrive process (tone transition emphasis process) is a process of, in a case where the input grayscale level for the current frame is higher than the input grayscale level for a past frame, temporarily outputting a grayscale level higher than the input grayscale level for the current frame and in a case where the input grayscale level for the current frame is lower than the input grayscale level for a past frame, temporarily outputting a grayscale level lower than the input grayscale level for the current frame. This increases the response speed of liquid crystal.

The correction process that the correction circuit 140 carries out for the present embodiment is not limited to an overdrive process. The correction circuit 140 may be configured to carry out any other correction process that is carried out with reference to a past frame and the current frame.

The correction circuit 140 supplies the image data output section 150 with image data that the correction circuit 140 has subjected to a correction process. The correction circuit 140 also stores, as image data for a past frame, at least a portion of the image data for the current frame in the frame memory 120 which image data the correction circuit 140 has subjected to a correction process.

Image Data Output Section 150

The image data output section 150 outputs, as output data of the image processing device 100, image data supplied from the correction circuit 140.

Setting a Boundary in the Frame Memory 120

As mentioned above, the frame memory 120 has a variable boundary between an area for storing image data for the current frame and an area for storing image data for a past frame.

The boundary may be variable adaptively or non-adaptively. In a case where the boundary is adaptively variable, the memory control section (which controls storage areas of the frame memory) may, for instance, control the boundary between the two areas variably according to the amount of image data for the current frame and the amount of image data for a past frame. In other words, the memory control section may variably control a partition that defines an area for storing image data for the current frame and a partition that defines an area for storing image data for a past frame.

The memory control section may alternatively control the boundary according to the application for generating an image to be displayed and displaying such an image. For instance, in a case where the application for generating an image to be displayed is a game application, the memory control section may set the boundary in such a manner that the memory space for storing image data for a past frame is not smaller than a predetermined size. In a case where the application for generating an image to be displayed is an application for displaying a still image, the memory control section may set the boundary in such a manner that the memory space for storing image data for a past frame is absent.

In a case where the boundary is non-adaptively variable, the user or producer sets the boundary as appropriate. For instance, in a case where the display device 1 is configured to primarily display a still image, the producer may set the boundary in such a manner that the memory space for storing image data for a past frame is absent.

As described above, the frame memory 120 may have a variable boundary between an area for storing image data for the current frame and an area for storing image data for a frame previous to the current frame. This allows the memory space of the frame memory 120 to be used effectively.

The description below assumes as a more specific example that the frame memory 120 as a whole has a memory space of n×2m pixels (where n and m are each a nonnegative integer).

In a case where the correction circuit does not need to carry out a correction process, the area for storing image data for a past frame is absent, whereas the memory space of n×2m pixels is secured as an area for storing image data for the current frame. This allows a high-resolution current frame to be stored.

In a case where the correction circuit carries out a correction process, the memory space of n×m pixels is secured as an area for storing image data for the current frame, whereas the memory space of n×m pixels is secured as an area for storing image data for a past frame. This allows the frame memory 120 to be used effectively and a correction process to be carried out suitably.

### Embodiment 2

The following description will discuss a second embodiment of the present invention. For convenience of explanation, any member of the present embodiment that is identical in function to a member described for the embodiments above is assigned the same reference sign. Such a member is not described again here.

The display device 1 in accordance with the present embodiment is configured as illustrated in the block diagram of FIG. 1. The description below deals with specifically how the frame memory 120 in accordance with the present embodiment is used.

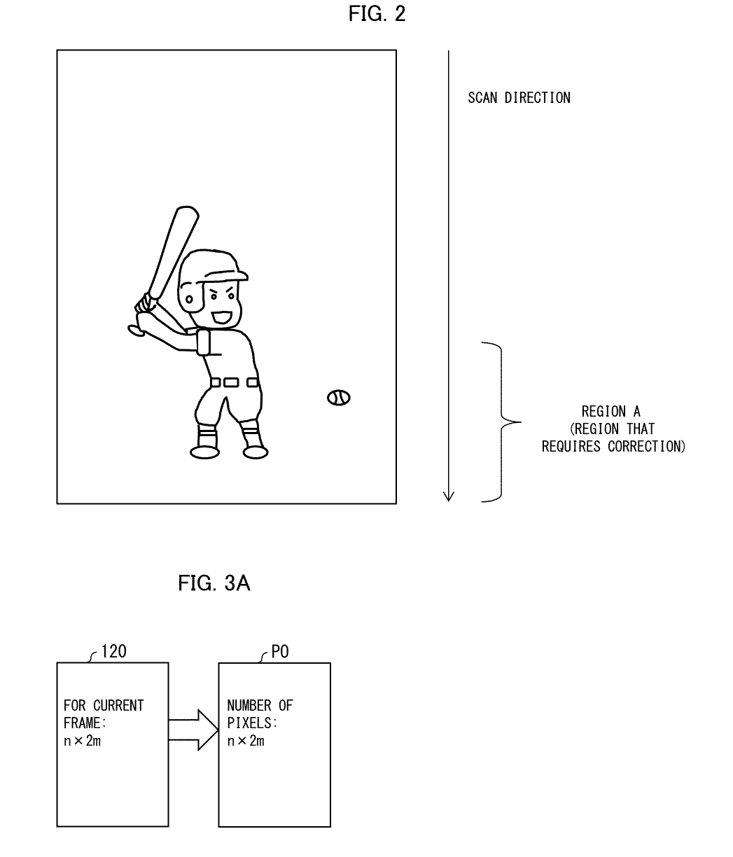

FIG. 2 is a diagram illustrating an example target image as a target of a process carried out by the display device 1 in accordance with the present embodiment.

As illustrated in FIG. 2, the display device 1 in accordance with the present embodiment processes a target image in a raster scan order as an example. Thus, as illustrated in FIG. 2, the display device 1 scans a target image from above toward below in terms of the up-down direction.

For the example illustrated in FIG. 2, the correction circuit 140 preferably carries out a correction process on the region A at a lower portion of the target image.

Typically, the intensity of a correction process by the correction circuit 140 may depend on the period of time of writing image data stored in the frame memory 120. FIG. 2 illustrates an example in which the correction circuit 140 preferably does not carry out a correction process on that portion of image data stored in the frame memory 120 which is written for the first portion of the time period and carries out a correction process on that portion of the image data stored in the frame memory 120 which is written for the second (remaining) portion of the time period.

In such cases, the frame memory 120 does not need to store a frame in its entirety as data for a past frame, and may store only a portion of image data which portion is referred to for a correction process by the correction circuit 140.

As described for Embodiment 1, which region of a past frame the frame memory 120 needs to store depends also on the application for generating an image to be displayed. The present embodiment is configured such that the memory control section, which controls the frame memory 120, adaptively changes the boundary in the frame memory 120 between an area for storing image data for the current frame and an area for storing image data for a past frame according to the type of the application. This allows the memory space of the frame memory 120 to be used effectively.

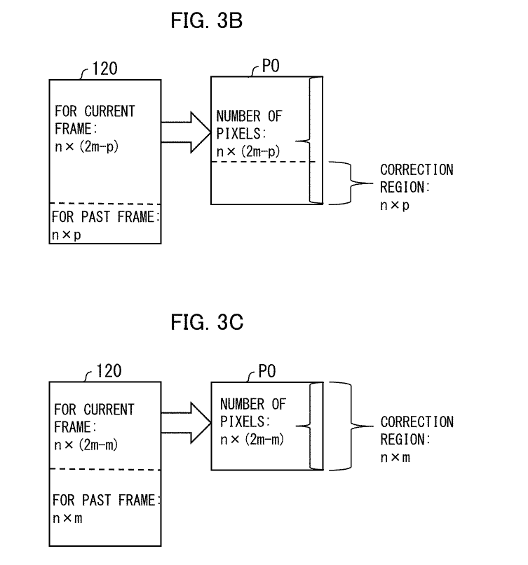

FIG. 3A to FIG. 3C are each a diagram specifically illustrating how a boundary is set in the frame memory 120 in accordance with the present embodiment. FIG. 3A to FIG. 3C illustrates example cases in each of which the frame memory 120 as a whole has a memory space of n×2m pixels (where n and m are each a nonnegative integer) as in Embodiment 1.

FIG. 3A illustrates an example in which the frame memory 120 does not store a past frame, and the correction circuit 140 does not carry out a correction process on the current frame. This example is configured such that the frame memory 120 stores the current frame in the entire memory space and that the correction circuit 140 does not carry out a correction process on the current frame stored in the frame memory 120 before outputting the current frame. The correction circuit 140 thus outputs image data PO having a resolution of n×2m.

FIG. 3B illustrates a case in which the frame memory 120 secures (i) a memory space of n×(2m−p) pixels (where p is a nonnegative integer, and 0≤p≤2m) for the current frame and (ii) a memory space of n×p pixels for a past frame. This example is configured such that the correction circuit 140 carries out a correction process on that area of the current frame, which is on the downstream side in the scan order and which is of n×p pixels, with reference to that area of a past frame which corresponds to the above area and which is of n×p pixels. This allows generation of corrected image data PO for the current frame of n×(2m−p) pixels of which image data PO an area that is on the downstream side in the scan order and that is of n×p pixels has been subjected to a correction process.

FIG. 3C illustrates a case in which the frame memory 120 secures (i) a memory space of n×(2m−m) pixels for the current frame and (ii) a memory space of n×m pixels for a past frame. This example is configured such that the correction circuit 140 carries out a correction process on the entire area of the current frame, which area is of n×m pixels, with reference to the entire area of a past frame which area is of n×m pixels. This allows generation of corrected image data PO for the current frame of n×m pixels of which image data PO the entire area has been subjected to a correction process.

The description above is of an example case in which the correction circuit 140 carries out a correction process on an area of the current frame which area is on the downstream side in the scan order. The present embodiment is, however, not limited to such a configuration. The present embodiment may be configured, for instance, such that the frame memory 120 stores a portion of image data outputted by the correction circuit 140 which portion is upstream or midstream in the scan order and that the correction circuit 140 carries out a correction process on a corresponding portion of the current frame.

### Embodiment 31

The following description will discuss a third embodiment of the present invention. For convenience of explanation, any member of the present embodiment that is identical in function to a member described for the embodiments above is assigned the same reference sign. Such a member is not described again here.

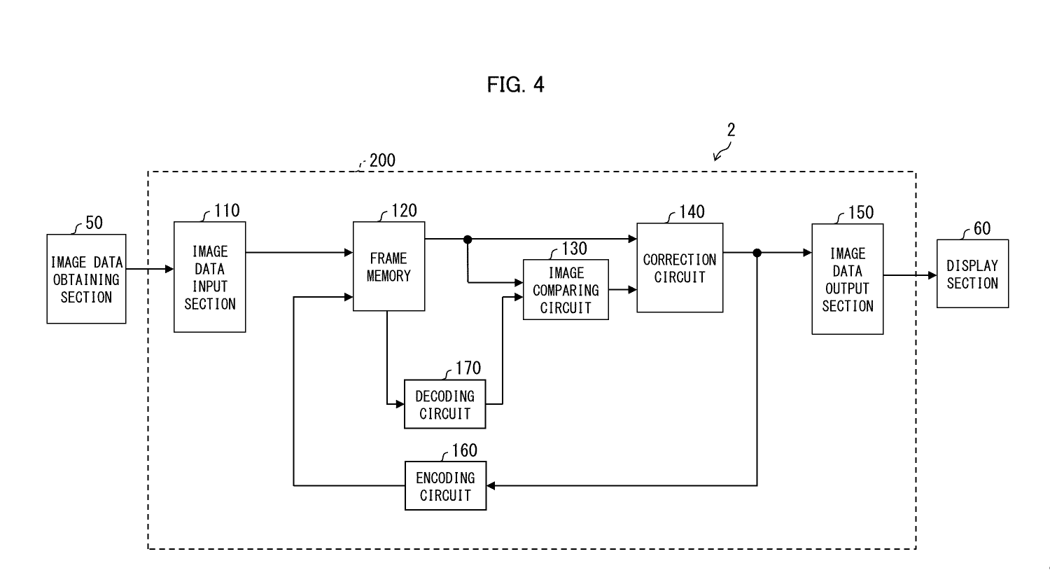

FIG. 4 is a block diagram illustrating the configuration of a display device 2 in accordance with the present embodiment. As illustrated in FIG. 4, the display device 2 includes an image data obtaining section 50, an image processing device 200, and a display section 60.

Image Processing Device 200

The image processing device 200 is configured in the same manner as the image processing device 100 illustrated in FIG. 1, and further includes an encoding circuit 160 and a decoding circuit 170.

The encoding circuit 160 carries out an encoding process on image data that the correction circuit 140 has outputted and thereby compresses the image data. The encoding circuit 160 stores the compressed image data as a past frame in the frame memory 120.

In other words, the encoding circuit 160 carries out an encoding process on a past frame that the correction circuit 140 has outputted, and the frame memory 120 stores, as a past frame, the image data that has been subjected to the encoding process.

A specific encoding process carried out by the encoding circuit 160 does not limit the present embodiment. The encoding process may be, for example, a block truncation coding (BTC) process. The present embodiment may alternatively be configured to carry out a thinning process in addition to an encoding process such as the above.

The decoding circuit 170 carries out a decoding process, which corresponds to the encoding process above, on compressed data for a past frame which compressed data is stored in the frame memory 120, and thereby generates decoded image data. The decoding circuit 170 supplies the decoded image data for a past frame to the image comparing circuit 130.

The image processing device 200 is otherwise configured similarly to the image processing device 100. Such other configuration is not described here again.

The image processing device 200, which is configured as described above, allows corrected image data to be subjected to a compression process before storing the image data as a reference past frame in the frame memory 120. This allows the memory space of the frame memory 120 to be used more effectively.

In a case where image data to be stored as a past frame in the frame memory 120 is subjected to an encoding process and a decoding process such as the above, the image may typically be degraded to an extent. However, image data to be stored as a past frame in the frame memory 120 is only for reference by the correction circuit 140. Thus, even if an image is degraded as above, it will only have a limited influence on image data that the correction circuit 140 finally outputs.

Even if, for instance, the encoding circuit 160 carries out an encoding process on image data for a past frame for compression by 2 to 1 or 3 to 1, the correction circuit 140 will still output image data having a good quality.

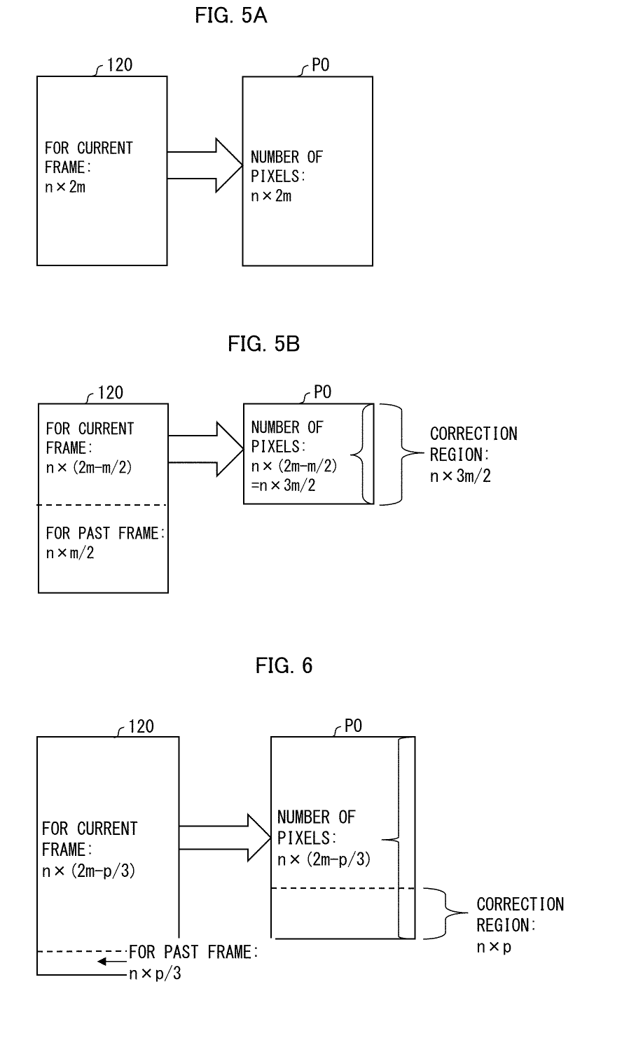

FIG. 5A to FIG. 5B are each a diagram specifically illustrating how a boundary is set in the frame memory 120 in accordance with the present embodiment. FIG. 5A to FIG. 5B illustrate example cases in each of which the frame memory 120 as a whole has a memory space of n×2m pixels (where n and m are each a nonnegative integer) as in the above embodiments.

FIG. 5A illustrates an example in which the frame memory 120 does not store a past frame, and the correction circuit 140 does not carry out a correction process on the current frame. This example is configured such that the frame memory 120 stores the current frame in the entire memory space and that the correction circuit 140 does not carry out a correction process on the current frame stored in the frame memory 120 before outputting the current frame. The correction circuit 140 thus outputs image data PO having a resolution of n×2m.

FIG. 5B illustrates a case in which the frame memory 120 secures (i) a memory space of n×(2m−m/2) pixels for the current frame and (ii) a memory space of n×m/2 pixels for a past frame. This example is configured such that the encoding circuit 160 compresses image data by 3 to 1 before storing the image data in the frame memory 120. Thus, the memory space of n×m/2 pixels for a past frame in the frame memory 120 corresponds to n×3m/2 pixels for decoded image data.

The correction circuit 140 carries out a correction process on the entire area of the current frame, which area is of n×3m/2 pixels, with reference to the entire area of a past frame which area is of n×(2m−m/2)=n×3m/2 pixels. This allows generation of corrected image data PO for the current frame of n×3m/2 pixels of which image data PO the entire area has been subjected to a correction process.

The above configuration, as a result, allows a higher resolution and a suitable correction process. Further, the above configuration prevents an increase in the circuit complexity of the image processing device 200, and also prevents a cost increase.

### Embodiment 41

The following description will discuss a fourth embodiment of the present invention. The present embodiment is a combination of Embodiments 2 and 3. For convenience of explanation, any member of the present embodiment that is identical in function to a member described for the embodiments above is assigned the same reference sign. Such a member is not described again here.

The display device 2 in accordance with the present embodiment is configured as illustrated in the block diagram of FIG. 4. The description below deals with specifically how the frame memory 120 in accordance with the present embodiment is used.

FIG. 6 is a diagram specifically illustrating how a boundary is set in the frame memory 120 in accordance with the present embodiment. FIG. 6 illustrates example cases in each of which the frame memory 120 as a whole has a memory space of n×2m pixels (where n and m are each a nonnegative integer) as in the above embodiments.

FIG. 6 illustrates a case in which the frame memory 120 secures (i) a memory space of n×(2m−p/3) pixels (where p is a nonnegative integer, and 0≤p≤2m) for the current frame and (ii) a memory space of n×p/3 pixels for a past frame. This example is configured such that the encoding circuit 160 compresses image data by 3 to 1 before storing the image data in the frame memory 120. Thus, the memory space of n×p/3 pixels for a past frame in the frame memory 120 corresponds to n×p pixels for decoded image data.

The correction circuit 140 carries out a correction process on that area of the current frame, which is on the downstream side in the scan order and which is of n×p pixels, with reference to that area of a past frame which corresponds to the above area and which is of n×p pixels. This allows generation of corrected image data PO for the current frame of n×(2m−p/3) pixels of which image data PO an area that is on the downstream side in the scan order and that is of n×p pixels has been subjected to a correction process.

The above configuration, as a result, allows a higher resolution and a suitable correction process. Further, the above configuration prevents an increase in the circuit complexity of the image processing device 200, and also prevents a cost increase.

### Software Implementation Example

Control blocks of the image processing device 100, 200 (particularly, the image comparing circuit 130 and the correction circuit 140) can be realized by a logic circuit (hardware) provided in an integrated circuit (IC chip) or the like or can be alternatively realized by software.

In the latter case, the image processing device 100, 200 includes a computer that executes instructions of a program that is software realizing the foregoing functions. The computer includes, for example, at least one processor (control device) and at least one computer-readable storage medium that stores the program. An object of the present invention can be achieved by the processor of the computer reading and executing the program stored in the storage medium. The processor is, for example, a central processing unit (CPU). Examples of the storage medium encompass “a non-transitory tangible medium” such as a read-only memory (ROM), a tape, a disk, a card, a semiconductor memory, and a programmable logic circuit. The computer may further include, for example, a random access memory (RAM) in which the program is loaded. The program can be supplied to or made available to the computer via any transmission medium (such as a communication network or a broadcast wave) which allows the program to be transmitted. Note that an aspect of the present invention can also be achieved in the form of a computer data signal in which the program is embodied via electronic transmission and which is embedded in a carrier wave.

[Recap]

An image processing device in accordance with a first aspect of the present invention includes: an input section (image data input section 110) configured to accept input image data; a frame memory (120) configured to store image data for a current frame which image data is included in the input image data that the input section has accepted; and a correction section (image comparing circuit 130, correction circuit 140) configured to correct an image for the current frame, the correction section being configured to correct the image for the current frame with reference to a frame previous to the current frame, the frame memory being configured to further store image data for the previous frame.

The above configuration makes it possible to carry out a suitable correction process while preventing a cost increase.

An image processing device in accordance with a second aspect of the present invention is configured as in the first aspect and may be further configured such that the frame memory has a variable boundary between an area for storing the image data for the current frame and an area for storing the image data for the previous frame.

The above configuration allows the memory space of the frame memory to be used effectively.

An image processing device in accordance with a third aspect of the present invention is configured as in the second aspect and may further include: a memory control section configured to change the boundary according to an application for generating or displaying the input image data.

The above configuration allows the memory space of the frame memory to be used effectively according to the application.

An image processing device in accordance with a fourth aspect of the present invention is configured as in any of the first to third aspects and may be further configured such that the correction section is configured to carry out an overdrive process in order to correct the image for the current frame.

The above configuration allows the memory space of the frame memory to be used effectively and an overdrive process to be carried out suitably.

An image processing device in accordance with a fifth aspect of the present invention is configured as in any of the first to fourth aspects and may further include: an encoding section (encoding circuit 160); and a decoding section (decoding circuit 170), wherein the encoding section is configured to encode the image data for the previous frame, the frame memory is configured to store the image data for the previous frame which image data has been encoded by the encoding section, and the decoding section is configured to decode the image data stored in the frame memory and supply the decoded image data to the correction section.

The above configuration allows the memory space of the frame memory to be used more effectively.

A display device in accordance with a sixth aspect of the present invention may include: an image processing device according to any of the first to fifth aspects; and a display section (60) configured to display the image that has been corrected by the correction section.

The present invention is not limited to the embodiments, but can be altered by a skilled person in the art within the scope of the claims. The present invention also encompasses, in its technical scope, any embodiment derived by combining technical means disclosed in differing embodiments. Further, it is possible to form a new technical feature by combining the technical means disclosed in the respective embodiments.

### REFERENCE SIGNS LIST

1, 2 Display device
50 Image data obtaining section
60 Display section
100, 200 Image processing device
110 Image data input section
120 Frame memory
130 Image comparing circuit
140 Correction circuit
150 Image data output section
160 Encoding circuit
170 Decoding circuit

1. An image processing device, comprising:
an input section configured to accept input image data;
a frame memory configured to store image data for a current frame which image data is included in the input image data that the input section has accepted; and
a correction section configured to correct an image for the current frame,
the correction section being configured to correct the image for the current frame with reference to a frame previous to the current frame,
the frame memory being configured to further store image data for the previous frame.

2. The image processing device according to claim 1, wherein
the frame memory has a variable boundary between an area for storing the image data for the current frame and an area for storing the image data for the previous frame.

3. The image processing device according to claim 2, further comprising:
a memory control section configured to change the boundary according to an application for generating or displaying the input image data.

4. The image processing device according to claim 1, wherein
the correction section is configured to carry out an overdrive process in order to correct the image for the current frame.

5. The image processing device according to claim 1, further comprising:
an encoding section; and
a decoding section,
wherein
the encoding section is configured to encode the image data for the previous frame,
the frame memory is configured to store the image data for the previous frame which image data has been encoded by the encoding section, and
the decoding section is configured to decode the image data stored in the frame memory and supply the decoded image data to the correction section.

6. A display device, comprising:
an image processing device according to claim 1; and
a display section configured to display the image that has been corrected by the correction section.
